(19) United States
(12) Patent Application Publication
(10) Pub. No.: US 2018/0137756 A1
(43) Pub. Date: May 17, 2018

(54) DETECTING AND RESPONDING TO EMERGENCY VEHICLES IN A ROADWAY

(71) Applicant: Ford Global Technologies, LLC, Dearborn, MI (US)

(72) Inventors: Maryam Moosaei, Mishawaka, IN (US); Parsa Mahmoudieh, Vallejo, CA (US); Scott Vincent Myers, Camarillo, CA (US); Ramchandra Ganesh Karandikar, Sunnyvale, CA (US)

(21) Appl. No.: 15/354,601

(22) Filed: Nov. 17, 2016

(51) Int. Cl. G08G 1/0967; G08G 1/16; G05D 1/00

(52) U.S. Cl. CPC G08G 1/096725; G05D 1/0088; G08G 1/163

(57) ABSTRACT

The present invention extends to methods, systems, and computer program products for detecting and responding to emergency vehicles in a roadway. Aspects of the invention can be used to detect emergency vehicles and properly yield to emergency vehicles depending on roadway configuration. A vehicle includes a plurality of sensors. The vehicle also includes vehicle to vehicle (V2V) communication capabilities and has access to map data. Sensor data from the plurality of sensors along with map data is provided as input to a neural network (either in the vehicle or in the cloud). Based on sensor data, the neural network detects when one or more emergency vehicles are approaching the vehicle. From a roadway configuration, a vehicle can use the plurality of sensors to automatically (and safely) yield to detected emergency vehicle(s). Automatically yielding can include one or more of: slowing down, changing lanes, stopping, etc.

### CROSS-REFERENCE TO RELATED APPLICATIONS

Not applicable.

### BACKGROUND

### 1. Field of the Invention

This invention relates generally to yielding to emergency vehicles, and, more particularly, to detecting and responding to emergency vehicles in a roadway.

### 2. Related Art

When emergency vehicles are responding to emergency, other vehicles on a roadway are required to yield to the emergency vehicles. Emergency vehicles including ambulances, fire vehicles, and police vehicles. How to properly yield can vary depending on the roadway configuration.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates detecting and responding to an emergency vehicle in a roadway.

FIG. 3 illustrates a flow chart of an example method for detecting and responding to an emergency vehicle in a roadway.

FIG. 4 illustrates an example data flow for formulating a response to a detected emergency vehicle.

FIG. 5A illustrates an example urban roadway environment.

FIG. 5B illustrates an example highway roadway environment.

### DETAILED DESCRIPTION

The present invention extends to methods, systems, and computer program products for detecting and responding to emergency vehicles in a roadway.

In general, aspects of the invention can be used to detect emergency vehicles (e.g., ambulances, fire vehicles, police vehicles, etc.) and properly yield to emergency vehicles depending on the roadway configuration. A vehicle includes a plurality of sensors including: one or more cameras, a LIDAR sensor, one or more ultrasonic sensors, one or more radar sensors, and one or more microphones. The vehicle also includes vehicle to vehicle (V2V) communication capabilities and has access to map data. Sensor data from the plurality of sensors along with map data is provided as input to a neural network (either in the vehicle or in the cloud). Based on sensor data, the neural network detects when one or more emergency vehicles are approaching the vehicle.

A vehicle can include multi-object tracking capabilities to track multiple emergency vehicles.

In one aspect, an autonomous vehicle automatically yields to one or more detected emergency vehicles. Based on map data, the autonomous vehicle can determine a roadway configuration (e.g., urban, highway, interstate, etc.). From the roadway configuration, the autonomous vehicle can use one or more cameras and one or more microphones to automatically (and safely) yield to the emergency vehicle(s). Automatically yielding can include one or more of: slowing down, changing lanes, stopping, etc. depending on the roadway configuration. The autonomous vehicle can use LIDAR sensors, ultrasound sensors, radar sensors, and cameras for planning a path that includes one or more of: safely changing lanes, slowing down, or stopping.

In an urban environment, an autonomous vehicle can detect if an emergency vehicle is in the same lane as the autonomous vehicle, on the left side of the autonomous vehicle, or on the right side of the autonomous vehicle. If the emergency vehicle is in the same lane, the autonomous vehicle checks to the right and, if there is room, moves to the right (e.g., into another lane or to the shoulder) and slows down and stops. If there is no room to the right, the autonomous vehicle checks to the left and, if there is room, moves to the left (e.g., into another lane, a shoulder, or median) and slows down and stops. If there is no room to safely move to either side, the autonomous vehicle slows down and/or stops.

In a highway environment, an autonomous vehicle can follow a similar procedure. The autonomous vehicle can slow down but may not come to a stop.

In another aspect, a human driver is driving a vehicle that includes the described mechanisms for automatically detecting emergency vehicles. When the vehicle detects an emergency vehicle, the vehicle can activate an audio and/or a visual notification within the vehicle cabin. The audio and/or a visual notification alerts the human driver to the presence of the emergency vehicle. The human driver can then manually manipulate vehicle controls to yield to the emergency vehicle.

In some aspects, emergency vehicles are also equipped with V2V communication capabilities. The emergency vehicles can use V2V communication to notify other vehicles in the area of an intended travel path. Based on intended travel paths of emergency vehicles, other vehicles can adjust (either automatically or manually) to more effectively yield to the emergency vehicles.

In one more specific aspect, a vehicle includes a plurality of microphones, a plurality of cameras (e.g., one in front, one in back, and one on each side), and V2V communication capabilities. The plurality of microphones are used for siren detection. The plurality of cameras are used to detect spinning lights and also to detect if an emergency vehicle is in the same lane as the vehicle. Learning and sensor fusion can be used to collectively handle data for both emergency vehicle detections and tracking and path planning.

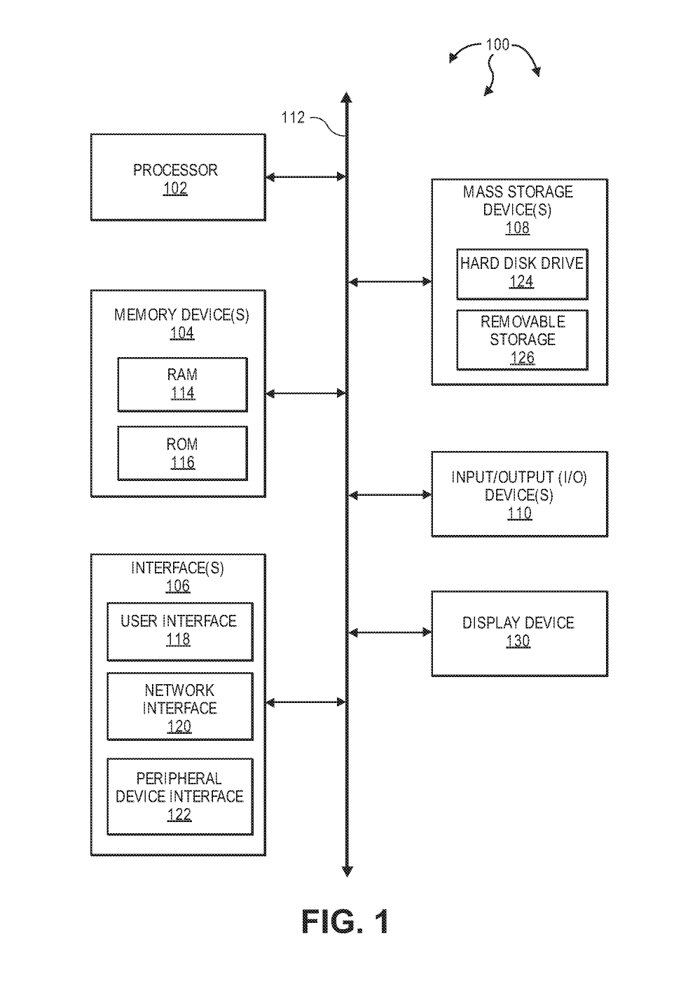

Aspects of the invention can be implemented in a variety of different types of computing devices. FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

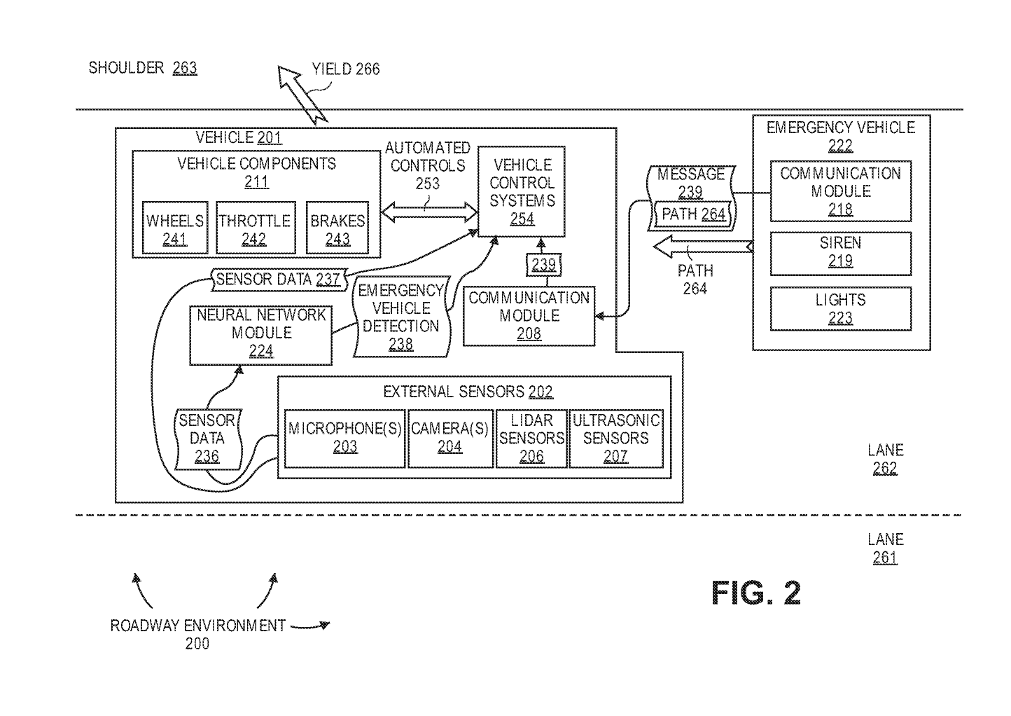

FIG. 2 illustrates an example roadway environment 200 that facilitates detecting and responding to an emergency vehicle in a roadway. As depicted, roadway environment 200 includes lanes 261 and 262 and shoulder 263. Vehicle 201 and emergency vehicle 222 are driving in lane 262. Vehicle 201 can be a car, truck, bus, van, etc. Similarly, emergency vehicle 222 can also be a car, truck, bus, van, etc.

As depicted, vehicle 201 includes external sensor(s) 202, communication module 208, vehicle control systems 254, and vehicle components 211. Each of external sensor(s) 202, communication module 208, vehicle control systems 254, and vehicle components 211, as well as their respective components can be connected to one another over (or be part of) a network, such as, for example, a PAN, a LAN, a WAN, a controller area network (CAN) bus, and even the Internet. Accordingly, each of external sensor(s) 202, communication module 208, vehicle control systems 254, and vehicle components 211, as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Communication module 208 can include hardware components (e.g., a wireless modem or wireless network card) and/or software components (e.g., a protocol stack) for wireless communication with other vehicles and/or computer systems. Communication module 208 can be used to facilitate vehicle to vehicle (V2V) communication as well as vehicle to infrastructure (V2I) communication. In some aspects, communication module 208 can receive data from other vehicles indicating a planned path of the other vehicle. Communication module 208 can forward the instructions to vehicle control systems 254. In one aspect, communication module 208 receives a planned path for an emergency vehicle. Communication module 208 can forward the planned path for the emergency vehicle to vehicle control systems 254.

External sensors 202 include one or more of: microphones 203, camera(s) 204, LIDAR sensor(s) 206, and ultrasonic sensor(s) 207. External sensors 202 may also include other types of sensors (not shown), such as, for example, radar sensors, acoustic sensors, and electromagnetic sensors. In general, external sensors 202 can sense and/or monitor objects in and/or around vehicle 201. External sensors 202 can output sensor data indicating the position and optical flow (i.e., direction and speed) of monitored objects. External sensors 202 can send sensor data to vehicle control systems 254.

Neural network module 224 can include a neural network architected in accordance with a multi-layer (or “deep”) model. A multi-layer neural network model can include an input layer, a plurality of hidden layers, and an output layer. A multi-layer neural network model may also include a loss layer. For classification of sensor data (e.g., an image), values in the sensor data (e.g., pixel-values) are assigned to input nodes and then fed through the plurality of hidden layers of the neural network. The plurality of hidden layers can perform a number of non-linear transformations. At the end of the transformations, an output node yields an indication of any approaching emergency vehicles.

In one aspect, neural network module 224 is run on cloud computing resources (e.g., compute, memory, and storage resources) in a cloud environment. In a cloud computing arrangement, communications module 208 uses V2I communication to send sensor data to neural network module 224 and to receive emergency vehicle detections from neural network module 224. Communication module 208 then forwards emergency vehicle detections to vehicle control systems 254.

In general, vehicle control systems 254 include an integrated set of control systems, for fully autonomous driving. For example, vehicle control systems 254 can include a cruise control system to control throttle 242, a steering system to control wheels 241, a collision avoidance system to control brakes 243, etc. Vehicle control systems 254 can receive sensor data from external sensors 202 and can receive data forwarded from communication module 208. Vehicle control systems 254 can send automated controls 253 to vehicle components 211 to control vehicle 201.

In one aspect, vehicle control systems 254 receive a planned path for an emergency vehicle forwarded from communication module 208. Vehicle control systems 254 can use sensor data on an ongoing basis along with the planned path to safely yield to the emergency vehicle.

As depicted, emergency vehicle 222 (e.g., an ambulance, a fire vehicle, a police vehicle, etc.) includes communication module 218, siren 219, and lights 223. When emergency vehicle 222 is responding to an emergency, siren 219 and/or lights 223 can be activated. Siren 219 can emit any of a variety of different sounds indicative of emergency vehicle 222 responding to an emergency. Lights 223 can be spinning lights. Lights 223 can include one or more lights and each of the one or more lights can be of any of a variety of different colors including: white, yellow, red, or blue.

Communication module 218 can include hardware components (e.g., a wireless modem or wireless network card) and/or software components (e.g., a protocol stack) for wireless communication with other vehicles and/or computer systems. Communication module 218 can be used to facilitate vehicle to vehicle (V2V) communication as well as vehicle to infrastructure (V2I) communication. In some aspects, communication module 228 sends data to other vehicles indicating a planned path of emergency vehicle 222.

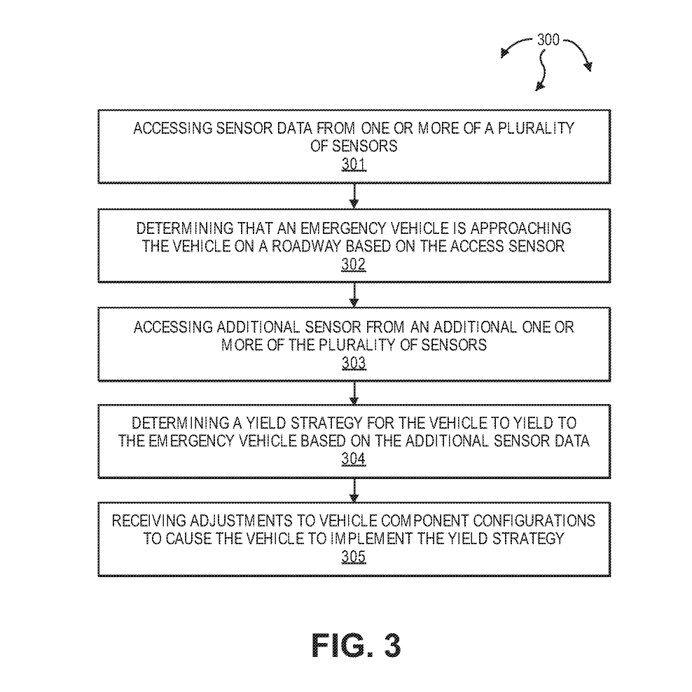

FIG. 3 illustrates a flow chart of an example method 300 for detecting and responding to an emergency vehicle in a roadway. Method 300 will be described with respect to the components and data of computer architecture 200.

As vehicle 201 is in motion, external sensors 202 can continually sense the environment around and/or adjacent to vehicle 201. Sensor data from external sensors 202 can be fused into sensor data 236. For example, sensor data from microphone(s) 203 and camera(s) 204 can be fused into sensor data 236. Microphone(s) 203 can detect sounds of siren 219. Camera(s) 204 can detect lights 223.

Method 300 includes accessing sensor data from one or more of the plurality of sensors (301). For example, neural network module 224 can access sensor data 236 from external sensors 202. Method 300 includes determining that an emergency vehicle is approaching the vehicle on a roadway based on the accessed sensor data (302). For example, neural network module 224 can output emergency vehicle detection 238 based on sensor data 236. Emergency vehicle detection 238 can indicate that emergency vehicle 222 is approaching vehicle 201 in lane 262.

Communication module 218 can send message 239 to vehicle 201. Message 239 indicates that emergency vehicle 222 intends to travel path 264 (e.g., straight ahead in lane 262). Communication module 208 can receive message 239 from emergency vehicle 222. Communication module 208 can forward message 239 to vehicle control systems 254.

Method 300 includes accessing additional sensor from an additional one or more of the plurality of sensors (303). For example, control systems 254 can access sensor data 237 from external sensors 202. As vehicle 201 continues in motion, external sensors 202 can continue to sense the environment around and/or adjacent to vehicle 201. Sensor data from external sensors 202 can be fused into sensor data 237.

Method 300 includes determining a yield strategy for the vehicle to yield to the emergency vehicle based on the additional sensor data (304). For example, vehicle control systems 254 can determine a yield strategy for vehicle 201 to yield to emergency vehicle 222 based on sensor data 237. Vehicle control systems 254 can use sensor data 237 to determine if other vehicles are in adjacent lanes (e.g., lane 261), speed and position of other vehicles, paths of other vehicles, other obstacles (e.g., signs, barricade, etc.), etc. A yield strategy can include one or more of: changing lanes (e.g., left or right), slowing down, and stopping. For example, vehicle control systems 254 can determine a yield strategy to pull into shoulder 263 and stop vehicle 201 until emergency vehicle 222 passes.

Method 300 includes receiving adjustments to vehicle component configurations to cause the vehicle to implement the yield strategy (305). For example, vehicle control systems 254 can send automated controls 253 to adjust vehicle components 211 to implement the yield strategy. One or more of wheels 241, throttle 242, and brakes 243 can receive adjustments (configuration changes) to implement yield 266. For example, wheels 241 can be adjusted to turn vehicle 201 into shoulder 263. Throttle 242 and brakes 243 can be adjusted to stop vehicle 201.

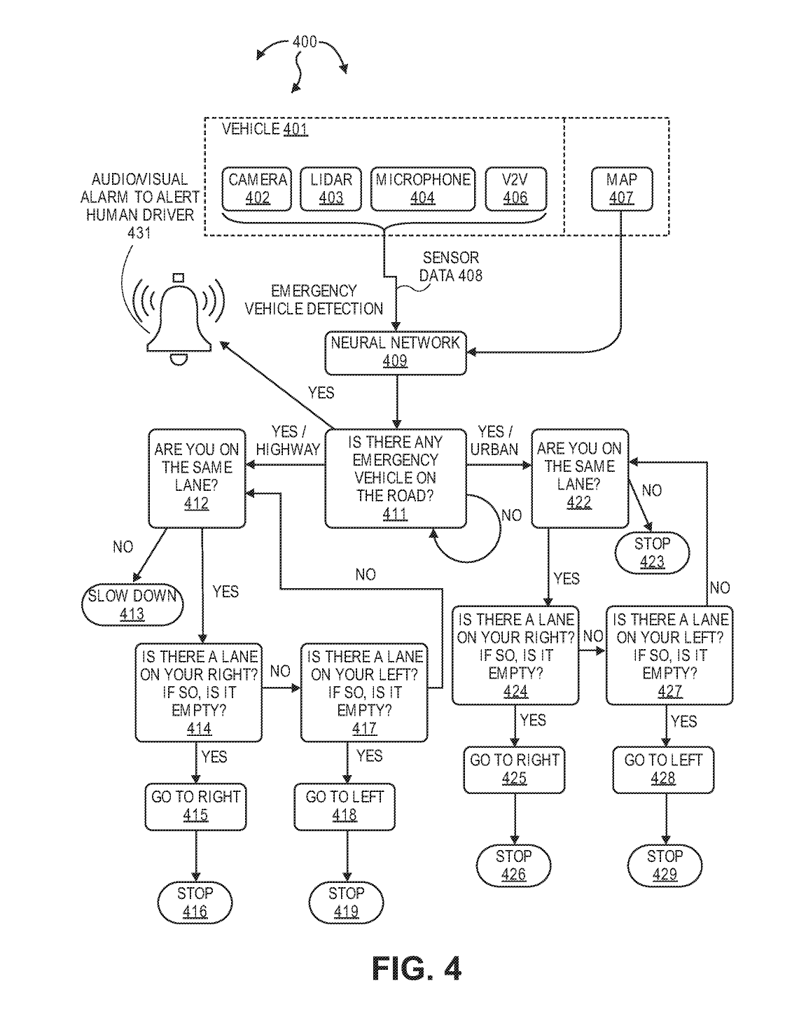

FIG. 4 illustrates an example data flow 400 for formulating a response to a detected emergency vehicle. As depicted, vehicle 401 includes camera 402, LIDAR 403, microphone 404, vehicle to vehicle (V2V) communication 406, and map 407. Vehicle 401 can be an autonomous vehicle or can be a vehicle that is controlled by a human driver. Sensors data from one or more of camera 402, LIDAR 403, microphone 404 can be fused together into sensor data 408. Map 407 and sensor data 408 can be provided as input to neural network 409. Based on sensor data 408, neural network 409 can determine if there is any emergency vehicle on the road with vehicle 401 (411). Based on map 407, neural network 409 can also determine if vehicle 401 is in an urban roadway environment or in a highway roadway environment.

If neural network 409 does not detect an emergency vehicle on the road (NO at 411), vehicle 401 can re-check for emergency vehicles. Checking for emergency vehicles can continue on an ongoing basis while vehicle 401 is on a roadway.

If neural network 409 detects an emergency vehicle on the road (YES at 411) and vehicle 401 is being driven by a human driver, audio/visual alarm 431 can be activated in the cabin on vehicle 401 to alert the human driver. Based on the roadway environment, the human driver can then yield to the emergency vehicle(s) as appropriate.

In one aspect, the emergency vehicle can also send an anticipated path of travel for the emergency vehicle to vehicle 401 via V2V communication 406.

If there is an emergency vehicle on the road and vehicle 401 is in a highway roadway environment (YES/Highway at 411), vehicle 401 can formulate and implement a strategy to automatically yield to the emergency vehicle. Vehicle 401 can determine (e.g., from additional sensor data and/or the emergency vehicle's anticipated path of travel) if vehicle 401 and an emergency vehicle are in the same lane (412). If vehicle 401 is not in the same lane as an emergency vehicle (NO at 412), vehicle 401 can slow down (413) (or stop) so that the emergency vehicle can pass.

If vehicle 401 is in the same lane as an emergency vehicle (YES at 412), vehicle 401 can determine if there is an empty lane to the right of vehicle 401 (414). If there is an empty lane to the right (YES at 414), vehicle 401 can pull into the right lane (415) and stop (416) (or pull into the right lane and slow down). If there is not an empty lane to the right of vehicle 401 (NO at 414) (e.g., other traffic is in the lane to the right), vehicle 401 can determine if there is an empty lane to the left of vehicle 401 (417). If there is an empty lane to the left (YES at 417), vehicle 401 can pull into the left lane (418) and stop (419) (or pull into the left lane and slow down).

If there is not an empty lane to the left (NO at 417), vehicle 401 can again determine if vehicle 401 is in the same lane as an emergency vehicle (412). As the emergency vehicle and other vehicles in the highway roadway environment travel, vehicle positions and lane availability can change. For example, the emergency vehicle can change lanes (or pull into a median or onto a shoulder) and/or lanes to the right of vehicle 401 and/or to the left of vehicle 401 can free up. Vehicle 401 can continual re-check for appropriate ways to automatically yield to the emergency vehicle.

If there is an emergency vehicle on the road and vehicle 401 is in an urban roadway environment (YES/Urban at 411), vehicle 401 can formulate and implement a strategy to automatically yield to the emergency vehicle. Vehicle 401 can determine (e.g., from additional sensor data and/or the emergency vehicle's anticipated path of travel) if vehicle 401 and an emergency vehicle are in the same lane (422). If vehicle 401 is not in the same lane as an emergency vehicle (NO at 422), vehicle 401 can stop (423) (or slow down) so that the emergency vehicle can pass.

If vehicle 401 is in the same lane as an emergency vehicle (YES at 422), vehicle 401 can determine if there is an empty lane to the right of vehicle 401 (424). If there is an empty lane to the right (YES at 424), vehicle 401 can pull into the right lane (425) and stop (426) (or pull into the right lane and slow down). If there is not an empty lane to the right of vehicle 401 (NO at 424) (e.g., other traffic is in the lane to the right), vehicle 401 can determine if there is an empty lane to the left of vehicle 401 (427). If there is an empty lane to the left (YES at 427), vehicle 401 can pull into the left lane (428) and stop (429) (or pull into the left lane and slow down).

If there is not an empty lane to the left (NO at 427), vehicle 401 can again determine if vehicle 401 is in the same lane as an emergency vehicle (422). As the emergency vehicle and other vehicles in the highway roadway environment travel, vehicle positions and lane availability can change. For example, the emergency vehicle can change lanes (or pull into a median or onto a shoulder) and/or lanes to the right of vehicle 401 and/or to the left of vehicle 401 can free up. Vehicle 401 can continual re-check for an appropriate strategy to automatically yield to the emergency vehicle.

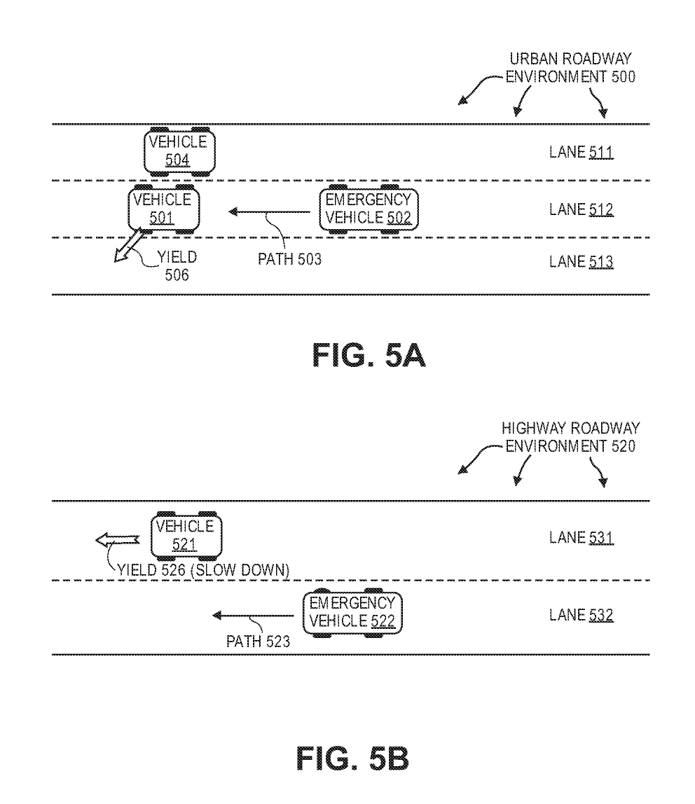

FIG. 5A illustrates an example urban roadway environment 500. Urban roadway environment 500 includes lanes 511, 512, and 513. Vehicle 504 is traveling in lane 511. Vehicle 501 and emergency vehicle 502 are traveling in lane 512. Vehicle 501 can detect the approach of emergency vehicle 502. Emergency vehicle 502 can also transmit data indicating an intent to travel path 503 to vehicle 501. Vehicle 501 can determine that vehicle 501 and emergency vehicle 502 are both in lane 512. Vehicle 501 can determine that lane 511 (a lane to the right) is occupied by vehicle 504. As such, vehicle 501 formulates a strategy to yield 506 to emergency vehicle 502 by moving into lane 513 and possibly slowing down or even stopping.

FIG. 5B illustrates an example highway roadway environment 520. Highway roadway environment 500 includes lanes 531 and 532. Vehicle 521 is traveling in lane 531. Emergency vehicle 522 is traveling in lane 532. Vehicle 521 can detect the approach of emergency vehicle 522. Emergency vehicle 522 can also transmit data indicating an intent to travel path 523 to vehicle 521. Vehicle 521 can determine that vehicle 521 and emergency vehicle 502 are in different lanes. As such, vehicle 521 formulates a strategy to yield 526 to emergency vehicle 502 by slowing down (or even stopping).

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, sensor data, maps, emergency vehicle detections, V2V messages, yielding strategies, intended paths of travel, audio/visual alerts, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, sensor data, maps, emergency vehicle detections, V2V messages, yielding strategies, intended paths of travel, audio/visual alerts, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed:

1. At a vehicle, a method for yielding to an emergency vehicle comprising:
accessing sensor data from a plurality of sensors at the vehicle;
detect that the emergency vehicle is approaching the vehicle on a roadway based on the accessed sensor data;
determining a yield strategy for the vehicle to yield to the emergency vehicle based on additional sensor data; and
automatically controlling vehicle components to cause the vehicle to implement the yield strategy.

2. The method of claim 1, further comprising:
accessing the additional sensor data from the plurality of sensors; and
receiving vehicle to vehicle communication from the emergency vehicle, the vehicle to vehicle communication notifying the vehicle of an intended path of the emergency vehicle.

3. The method of claim 2, wherein determining a yield strategy for the vehicle to yield to the emergency vehicle comprises determining a yield strategy based on the intended path of the emergency vehicle and the additional sensor data accessed from the plurality of sensors.

4. The method of claim 1, wherein accessing sensor data from a plurality of sensors at the vehicle comprises accessing sensor data representing the sound of a siren detected by a microphone; and
wherein detecting that the emergency vehicle is approaching the vehicle on a roadway comprises detecting that the emergency vehicle is approaching the vehicle based on the sensor data representing the sound of the siren.

5. The method of claim 1, wherein determining a yield strategy comprises determining that the vehicle is to perform one or more of: changing lanes, slowing down, or stopping.

6. The method of claim 1, wherein automatically controlling vehicle components to cause the vehicle to implement the yield strategy comprises automatically controlling vehicle components to cause the vehicle to perform one or more of: changing lanes, slowing down, or stopping.

7. A vehicle comprising:
one or more processors;
system memory coupled to one or more processors, the system memory storing instructions that are executable by the one or more processors;
a plurality of sensors for sensing an external environment in the vicinity of the vehicle;
the one or more processors configured to execute the instructions stored in the system memory to yield to an emergency vehicle, including the following:
access sensor data from one or more of the plurality of sensors;
determine that the emergency vehicle is approaching the vehicle on a roadway based on the accessed sensor data;
access additional sensor data from another one or more of the plurality of sensors;
determine a yield strategy for the vehicle to yield to the emergency vehicle based on the additional sensor data; and
receive adjustments to vehicle component configurations to cause the vehicle to implement the yield strategy.

8. The vehicle of claim 7, wherein the plurality of sensors comprises one or more sensors selected from among: microphones, cameras, LIDAR sensors, and ultrasonic sensors.

9. The vehicle of claim 7, further comprising the one or more processors configured to execute the instructions stored in the system memory to receive vehicle to vehicle communication from the emergency vehicle, the vehicle to vehicle communication notifying the vehicle of an intended path of the emergency vehicle.

10. The vehicle of claim 9, wherein the one or more processors configured to execute the instructions stored in the system memory to determine a yield strategy for the vehicle comprises the one or more processors configured to execute the instructions stored in the system memory to determine a yield strategy based on the intended path of the emergency vehicle.

11. The vehicle of claim 7, wherein the one or more processors configured to execute the instructions stored in the system memory to access sensor data from one or more of the plurality of sensors comprises the one or more processors configured to execute the instructions stored in the system memory to access sensor data from a microphone, the accessed sensor data representing the sound of a siren detected by the microphone.

12. The vehicle of claim 11, wherein the one or more processors configured to execute the instructions stored in the system memory to detect that the emergency vehicle is approaching the vehicle on a roadway comprises the one or more processors configured to execute the instructions stored in the system memory to detect that the emergency vehicle is approaching the vehicle based on the accessed sensor data representing the sound of the siren.

13. The vehicle of claim 11, wherein the one or more processors configured to execute the instructions stored in the system memory to determine a yield strategy comprises the one or more processors configured to execute the instructions stored in the system memory to determine that the vehicle is to perform one or more of: changing lanes, slowing down, or stopping.

14. The vehicle of claim 11, wherein the one or more processors configured to execute the instructions stored in the system memory to receive adjustments to vehicle component configurations to cause the vehicle to implement the yield strategy comprises the one or more processors configured to execute the instructions stored in the system memory to receive adjustments to vehicle component configurations to cause the vehicle to perform one or more of: changing lanes, slowing down, or stopping.

15. The vehicle of claim 11, wherein the vehicle is an autonomous vehicle; and
wherein the one or more processors configured to execute the instructions stored in the system memory to receive adjustments to vehicle component configurations to cause the vehicle to implement the yield strategy comprises the one or more processors configured to execute the instructions stored in the system memory to cause vehicle control systems within the autonomous vehicle to automatically adjust vehicle component configurations to implement the yield strategy.

16. A computer program product for use at an autonomous vehicle, the computer program product for implementing a method for yielding to an emergency vehicle, the computer program product comprising one or more computer storage devices having stored thereon computer-executable instructions that, when executed by a processor, cause the vehicle to perform the method including the following:
access sensor data from one or more of a plurality of sensors, the plurality of sensors for sensing the external environment in the vicinity of the autonomous vehicle;
determine that the emergency vehicle is approaching the vehicle on a roadway based on the accessed sensor data;
access additional sensor data from an additional one or more of the plurality of sensors;
determine a yield strategy for the vehicle to yield to the emergency vehicle based on the additional sensor data; and
automatically adjust vehicle component configurations to cause the vehicle to implement the yield strategy.

17. The computer program product of claim 16, wherein computer-executable instructions that, when executed, cause the vehicle to access sensor data from one or more of: a microphone, a camera, a LIDAR sensor, or an ultrasonic sensor.

18. The computer program product of claim 16, wherein computer-executable instructions that, when executed, cause the vehicle to access sensor data from one or more of the plurality of sensors comprise computer-executable instructions that, when executed, cause the vehicle to access sensor data from a microphone, the accessed sensor data representing the sound of a siren detected by the microphone; and
wherein computer-executable instructions that, when executed, cause the vehicle to detect that the emergency vehicle is approaching the vehicle on a roadway comprise computer-executable instructions that, when executed, cause the vehicle to detect that the emergency vehicle is approaching the vehicle based on the accessed sensor data representing the sound of the siren.

19. The computer program product of claim 16, wherein computer-executable instructions that, when executed, cause the vehicle to determine a yield strategy comprise computer-executable instructions that, when executed, cause the vehicle to determine that the vehicle is to perform one or more of: changing lanes, slowing down, or stopping; and
wherein computer-executable instructions that, when executed, cause the vehicle to automatically adjust vehicle component configurations comprise computer-executable instructions that, when executed, cause the vehicle to automatically adjust vehicle component configurations to perform one or more of: changing lanes, slowing down, or stopping.

20. The computer program product of claim 16, wherein computer-executable instructions that, when executed, cause the vehicle to automatically adjust vehicle component configurations comprise computer-executable instructions that, when executed, cause the vehicle to automatically adjust vehicle component configurations of one or more of: a steering component for the autonomous vehicle, a throttle component for the autonomous vehicle, or a braking component for the autonomous vehicle.
